(19) United States
(12) Patent Application Publication
(10) Pub. No.: US 2009/0268551 A1
(43) Pub. Date: Oct. 29, 2009

(54) MIXER WITH BEARING TUBE FOR REDUCING BEATER SHAFT VIBRATION

(76) Inventor: Chen-Su LU, Taichung (TW)

Correspondence Address: BIRCH STEWART KOLASCH & BIRCH, PO BOX 747, FALLS CHURCH, VA, 22040-0747, US

(21) Appl. No.: 12/111,843

(22) Filed: Apr. 29, 2008

(51) Int. Cl. B01F 7/00

(52) U.S. Cl. 366/331

(57) ABSTRACT

A mixer is disclosed that includes an elongated bearing tube with at least two bearings therein in which a first one of the bearings is disposed at one end of the bearing tube and a second one of the bearings is disposed at the other end of the bearing tube. Shaft of an electric motor is rotatably supported by the bearings. Drive shaft of a beater secured to the motor shaft is capable of rotating with a minimum vibration.

### BACKGROUND OF THE INVENTION

1. Field of Invention

The invention relates to mixers and more particularly to a mixer having an elongated bearing tube with at least two spaced bearings therein so that shaft of an electric motor is rotatably supported by the bearings and drive shaft of a beater secured to the motor shaft is capable of rotating with a minimum vibration.

2. Description of Related Art

A conventional mixer is shown in a schematic longitudinal sectional view in FIG. 1. The mixer has a stub shaft 91 having an open end secured to one end of the drive shaft of a beater. Blades at the other end of the drive shaft of the beater may vibrate strongly (i.e., having a significant offset relative to the rotation axis of the beater as indicated by dash lines) due to the elongated drive shaft. This can not only shorten the useful life of the mixer but also cause danger to the person operating same.

Another conventional mixer is shown in a schematic longitudinal sectional view in FIG. 2. The mixer has a motor having a stub shaft operatively connected to a drive shaft of a beater 20 via a reduction gear. The upper portion of the beater 20 inside a casing with the reduction gear also mounted therein is supported by upper and lower bearings. Moreover, the portion of the beater 20 immediately below the casing is fitted in and threadedly secured to a pipe. However, the impeller 10 of the beater 20 also vibrates strongly in operation. Further, the structure of beater transmission mechanism (i.e., the components within the casing) is complicated, and expensive to manufacture.

There have been numerous suggestions in prior patents for mixers. For example, U.S. Pat. No. 6,796,706 discloses a food mixer. Thus, continuing improvements in the exploitation of mixer are constantly being sought.

### SUMMARY OF THE INVENTION

It is therefore one object of the invention to provide a mixer having an elongated bearing tube with at least two bearings therein in which a first one of the bearings is disposed at one end of the bearing tube and a second one of the bearings is disposed at the other end of the bearing tube. Shaft of an electric motor is rotatably supported by the bearings. Drive shaft of a beater secured to the motor shaft is capable of rotating with a minimum vibration.

The above and other objects, features and advantages of the invention will become apparent from the following detailed description taken with the accompanying drawings.

### BRIEF DESCRIPTION OF THE DRAWINGS

FIG. 1 is a schematic longitudinal sectional view of a conventional mixer;

FIG. 2 is a schematic longitudinal sectional view of another conventional mixer;

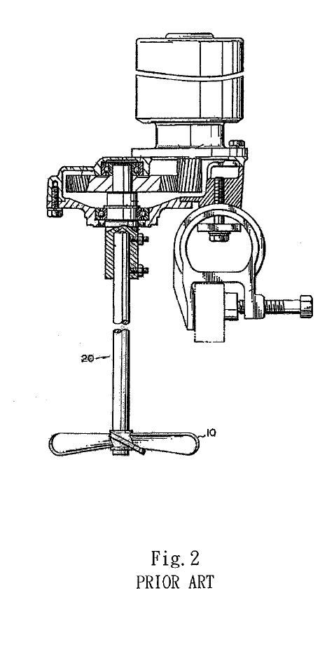

FIG. 3 is a perspective view of a mixer motor and associated beater transmission mechanism according to a first preferred embodiment of the invention;

FIG. 4 is an exploded view of the mixer motor and the beater transmission mechanism of FIG. 3;

FIG. 5 is a longitudinal sectional view of the mixer motor and the beater transmission mechanism of FIG. 3;

FIG. 6 is a schematic longitudinal sectional view showing a complete mixer incorporating the motor and associated beater transmission mechanism according to the first preferred embodiment;

FIG. 7 is a view similar to FIG. 3 showing the beater transmission mechanism of FIG. 3 operatively connected to a beater via a sprocket and belt type transmission mechanism in accordance with another configuration of the first preferred embodiment of the invention;

FIG. 8 is a perspective view of a mixer motor and associated beater transmission mechanism according to a second preferred embodiment of the invention;

FIG. 9 is a schematic longitudinal sectional view showing a complete mixer incorporating the motor and associated beater transmission mechanism according to the second preferred embodiment; and

FIG. 10 shows two schematic longitudinal sectional views for comparing the conventional beater transmission mechanism of FIG. 1 in the left side 10A with the beater transmission mechanism of the first preferred embodiment of the invention in the right side 10B.

### DETAILED DESCRIPTION OF THE INVENTION

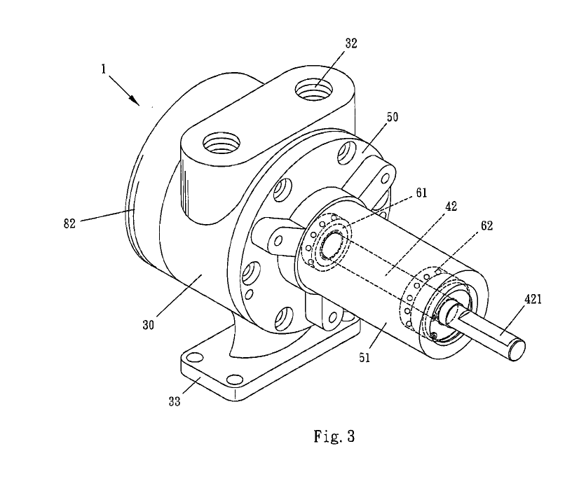

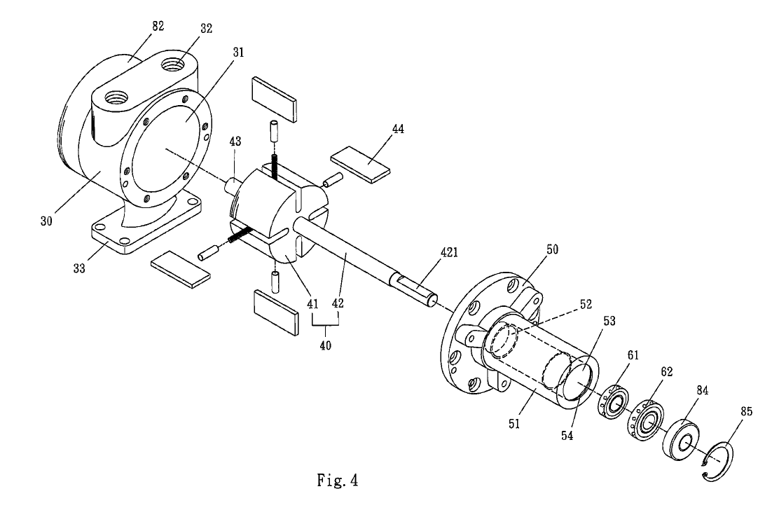

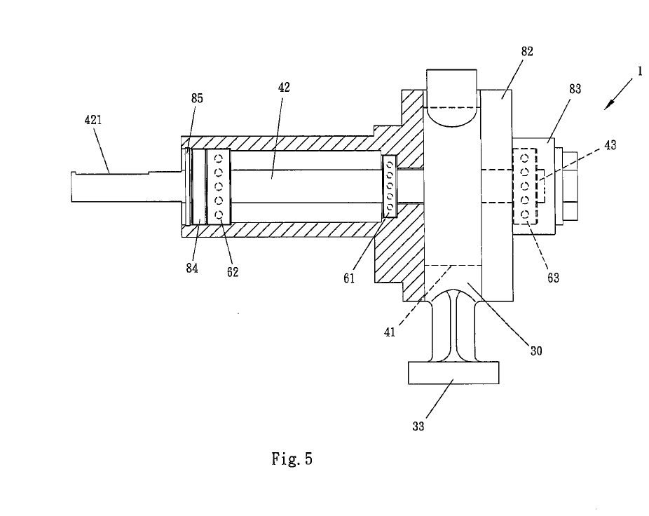

Referring to FIGS. 3 to 7, a mixer incorporates a motor assembly 1 in accordance with a first preferred embodiment of the invention is shown. The motor assembly 1 comprises a housing 30, a rotation mechanism 40, a mounting plate 50, a bearing tube 51 secured to the mounting plate 50, and a bearing assembly including first, second, and third bearings 61, 62, and 63. Each component is discussed in detail below.

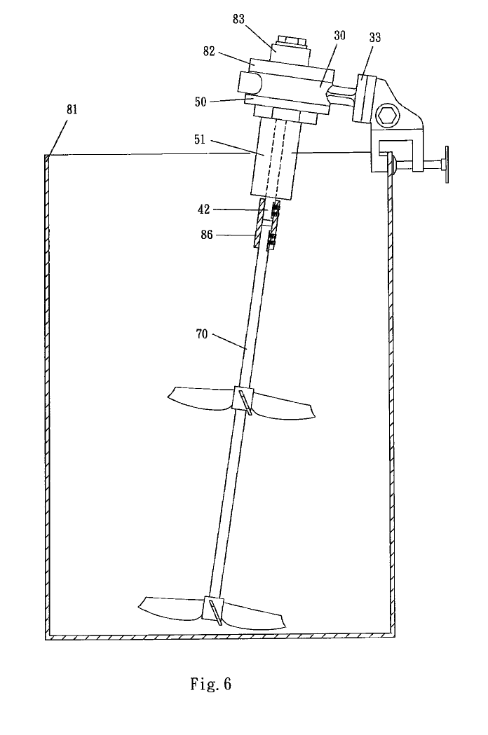

The cylindrical housing 30 comprises an internal space 31, two air vents 32 in communication with the space 31, and a base 33 secured to a mixing drum 81 by a clamp (not numbered) as shown in FIG. 6.

The rotation mechanism 40 comprises a rotor 41 mounted in the space 31, a forward extending first stub shaft 42 having one end fixedly fastened in the axial center of the rotor 41, the first stub shaft 42 having a flat 421 on the other end, the flat 421 being adapted to secure to, for example, the drive shaft of a beater by a fastening member as detailed later, a rearward extending second stub shaft 43 having the other end fixedly fastened in the axial center of the rotor 41, and four sets of bakelite 44 and its accessories mounted in the rotor 41 in an equally spaced fashion.

A rear disk 82 is mounted on the rear end of the housing 30 with the second stub shaft 43 axially passing through. The third bearing 63 is mounted on the rear end of the second stub shaft 43 so that the second stub shaft 43 is capable of rotating with a minimum friction. A rear cap 83 is mounted to the rear surface of the disk 82 for containing and sealing the third bearing 63 and the rear portion of the second stub shaft 43.

The mounting plate 50 is threadedly secured to the front edge of the housing 30. The bearing tube 51 extends forward from the mounting plate 50. The hollow of the bearing tube 51 is shaped as a stage of different diameters in which a first bore 52 of small diameter at one end of the hollow of the bearing tube 51 is in the mounting plate 50 and a second bore 53 of large diameter is adjacent the other end of the hollow of the bearing tube 51. An annular groove 54 is formed in the mouth of the second bore 53.

The first bearing 61 is mounted in the first bore 52. The second bearing 62 is mounted in the second bore 53. An oil ring 84 is mounted in the rear portion of the groove 54 proximate the second bearing 62. A C-ring 85 is mounted in the front portion (i.e., mouth) of the groove 54 for retaining the oil ring 84 in place. The first stub shaft 42 passes the first bore 52, the first bearing 61, the main portion of the hollow of the bearing tube 51, the second bearing 62, the oil ring 84, and the C-ring 85 to extend beyond with the flat 421 being exposed.

A mixer incorporating the first preferred embodiment of the motor and the beater transmission mechanism is shown in FIG. 6. A fastening sleeve 86 is secured to both the first stub shaft 42 and the drive shaft 70 of a beater.

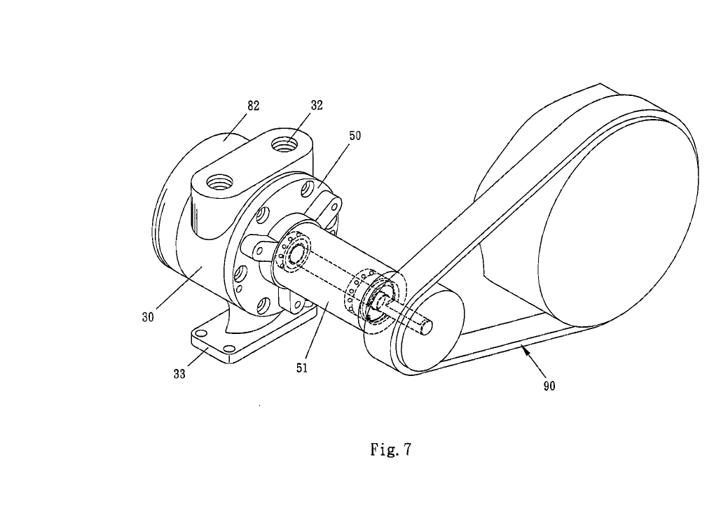

Another configuration of the first preferred embodiment of the mixer motor and the beater transmission mechanism according to the invention is shown in FIG. 7. The beater transmission mechanism is operatively connected to a beater (not shown) via a sprocket and belt type transmission mechanism 90.

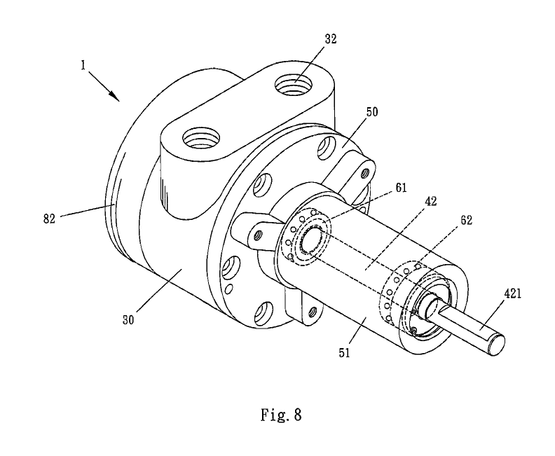

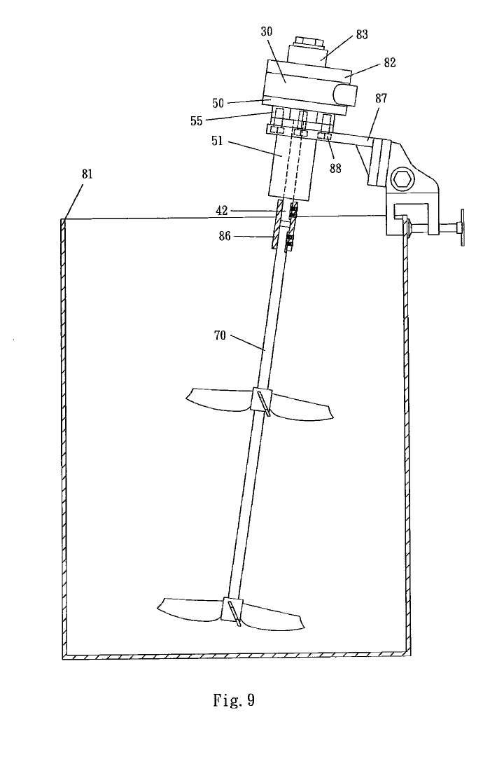

Referring to FIGS. 8 and 9, a mixer incorporates a motor assembly 1 in accordance with a second preferred embodiment of the invention is shown. The motor assembly 1 of the second preferred embodiment is the same as that shown in FIG. 3 except the following features. The base 33 is removed. A plurality of equally spaced threaded holes 55 are formed around an enlarged portion of the bearing tube 51 proximate the mounting plate 50. A bracket 87 has one end secured to the mixing drum 81 by a clamp (not numbered) and the other end secured to the bearing tube 51 by driving a plurality of fasteners (e.g., screws) 88 trough the other end of the bracket 87 into the threaded holes 55 (see FIG. 9).

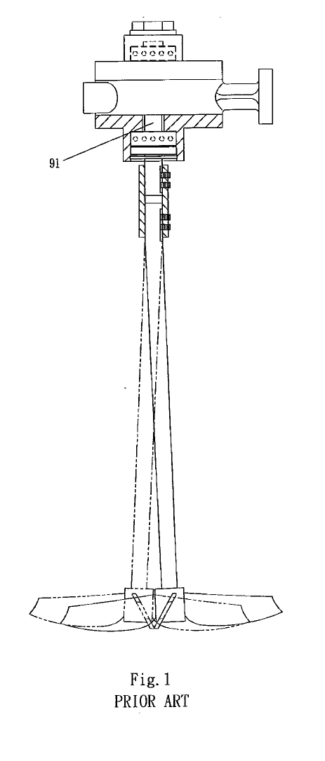

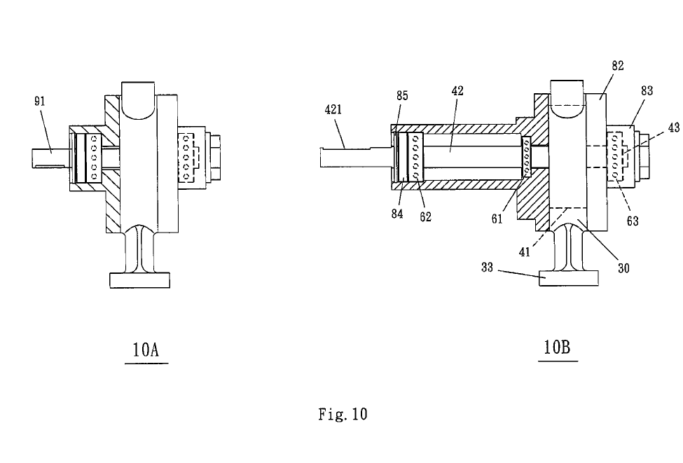

Referring to FIG. 10 in conjunction with FIG. 1 and FIGS. 3 to 9, it shows two schematic longitudinal sectional views for comparing the conventional beater transmission mechanism of FIG. 1 in the left side 10A with the beater transmission mechanism of the invention in the right side 10B. It is envisaged by the invention that the provision of the bearings 61, 62 in the bearing tube can cause the drive shaft of a beater, secured to the first stub shaft 42 and rotatably supported by the bearings 61, 62, to rotate with a minimum vibration. As a result, an offset of the drive shaft of the beater relative to the rotation axis thereof during operation is reduced to a minimum.

While the invention herein disclosed has been described by means of specific embodiments, numerous modifications could be made thereto by those skilled in the art without departing from the scope and spirit of the invention set forth in the claims.

What is claimed is:

1. A mixer comprising:
an electric motor having a shaft;
a mixing drum;
a beater transmission mechanism comprising a bearing tube and a plurality of bearings disposed in the bearing tube; and
a beater disposed in the mixing drum;
wherein the shaft of the motor passes the bearing tube and the bearings to be rotatably supported by the bearings and secured to the beater; and
a first one of the bearings is disposed at one end of the bearing tube and a second one of the bearings is disposed at the other end of the bearing tube.

2. The mixer of claim 1, wherein the shaft of the motor has a flat on its open end.

3. A mixer comprising:
an electric motor having a shaft;
a mixing drum;
a sprocket and belt unit;
a beater transmission mechanism comprising a bearing tube and a plurality of bearings disposed in the bearing tube; and
a beater disposed in the mixing drum;
wherein the shaft of the motor passes the bearing tube and the bearings to be rotatably supported by the bearings and secured to one end of the sprocket and belt unit which has the other end secured to the beater; and
a first one of the bearings is disposed at one end of the bearing tube and a second one of the bearings is disposed at the other end of the bearing tube.

4. The mixer of claim 3, wherein the shaft of the motor has a flat on its open end.
